(19) United States
(12) Patent Application Publication
(10) Pub. No.: US 2002/0013095 A1
(43) Pub. Date: Jan. 31, 2002

(54) CONNECTOR HAVING A SHIELD FOR SIGNAL CONTACTS

(76) Inventors: SATOSHI KATOH, TOKYO (JP); TADASHI KUMAMOTO, TOKYO (JP); TAKESHI OKUYAMA, TOKYO (JP); HIDEO MIYAZAWA, TOKYO (JP); YUKIHIRO MAITANI, TOKYO (JP)

Correspondence Address: STAAS & HALSEY LLP, 700 11TH STREET, NW, SUITE 500, WASHINGTON, DC, 20001, US

(21) Appl. No.: 09/418,975

(22) Filed: Oct. 14, 1999

(30) Foreign Application Priority Data
Feb. 25, 1999 (JP) 11-48509

(51) Int. Cl. H01R 13/648

(52) U.S. Cl. 439/625

(57) ABSTRACT

A connector for an electronic device has a plug with signal contacts and ground contacts arranged in an alternating sequence in two parallel rows. A shield portion is provided on each ground contact so as to cover an area around adjacent signal contacts so as to reduce crosstalk between adjacent signal contacts.

### BACKGROUND OF THE INVENTION

1. Field of the Invention

The present invention relates generally to an electronic device connector, and more particularly, to an electronic device connector having a shield for signal contacts.

2. Description of the Related Art

As electronic devices have become more sophisticated the connectors that are connected to these electronic devices have changed as well. Specifically, the pitch between connector terminals has tended to become smaller. At the same time, however, cable assembly involving such small-pitch connectors continues to require the highest accuracy and reliability.

Conventionally, in order to meet this need for accurate and reliable cable assembly involving small-pitch connectors, as shown in FIG. 1B the signal contacts 1a through 1e and the ground contacts 2 of both the connector plug and connector jack have been arranged in alternate sequence in two parallel rows when seen from the front of the engaging portions of the plug and jack.

According to this method, adjacent signal contacts in the same row, for example signal contacts 1b and 1c in FIG. 1B, are separated by a ground contact 2. As a result, the shield effect of the ground contact 2 reduces signal leakage between adjacent signal contacts, that is, crosstalk. At the same time, signal contacts 1d and 1e of the lower row shown in FIG. 1B are disposed so as to be offset one position from signal contacts 1a, 1b and 1c of the upper row shown in FIG. 1B, an arrangement which results in less crosstalk than the disposition shown in FIG. 1A, in which, for example, signal contacts 1f of the upper row and 1g of the lower row are disposed so as to be adjacent to each other.

### SUMMARY OF THE INVENTION

It is a general object of the present invention to provide an improved and useful connector capable of further reducing crosstalk in a connector having a plurality of signal contacts and ground contacts arranged in alternating sequence in two parallel rows, the two rows having opposed sequences such that a signal contact in one row is opposed by a ground contact in the other row and vice versa.

The above-described object of the present invention is achieved by a plug having a plurality of signal contacts and a plurality of ground contacts arranged in alternating sequence in two parallel rows, the two rows having opposed sequences such that a signal contact in one row is opposed by a ground contact in the other row and vice versa, a shield portion being provided on each ground contact.

Additionally, the above-described object of the present invention is also achieved by a plug having a plurality of signal contacts and a plurality of ground contacts arranged in alternating sequence in two parallel rows, the two rows having opposed sequences such that a signal contact in one row is opposed by a ground contact in the other row and vice versa, each ground contact having a jack engaging portion, the jack engaging portion having a size which shields a region opposite signal contacts between which one of the ground contacts is disposed.

According to the plug of the present invention, crosstalk between adjacent signal contacts can be reduced.

Additionally, the above-described object of the present invention is also achieved by a plug having a plurality of signal contacts and a plurality of ground contacts arranged in alternating sequence in two parallel rows, the two rows having opposed sequences such that a signal contact in one row is opposed by a ground contact in the other row and vice versa, a ground shield being extended from a conjoining portion of one of the ground contacts adjacent to a pressure-contacting portion of a respective one of the signal contacts.

According to the plug of the present invention, the ground contacts and signal contacts can be positioned closer to each other, that is, the pitch between connector terminals can be decreased, making it possible to make devices more compact.

Additionally, the above-described object of the present invention is also achieved by a jack having a plurality of signal contacts and a plurality of ground contacts arranged in alternating sequence in two parallel rows, the two rows having opposed sequences such that a signal contact in one row is opposed by a ground contact in the other row and vice versa, a shield portion being provided on each ground contact.

Additionally, the above-described object of the present invention is also achieved by a jack having a plurality of signal contacts and a plurality of ground contacts arranged in alternating sequence in two parallel rows, the two rows having opposed sequences such that a signal contact in one row is opposed by a ground contact in the other row and vice versa, each ground contact having a plug engaging portion, the plug engaging portion having a size which shields a region opposite signal contacts between which one of the ground contacts is disposed.

According to the jack of the present invention, crosstalk between adjacent signal contacts can be reduced.

### BRIEF DESCRIPTION OF THE DRAWINGS

Other objects, features and advantages of the present invention will become more apparent from the following detailed description when read in conjunction with the accompanying drawings, in which:

FIGS. 1A and 1B are diagrams showing two sets of two rows of ground contacts and signal contacts, one set having an identical alternation of ground contacts and signal contacts and another set having an opposed alternation of ground contacts and signal contacts, such that a signal contact in one row is opposed by a ground contact in the other row and vice versa;

FIG. 2 is a perspective view of a connector according to an embodiment of the present invention;

FIGS. 3A and 3B are an exploded perspective view of the connector plug of FIG. 2 and a schematic view of the arrangement of ground contacts and signal contacts as seen from a far side of the connector plug of FIG. 2 as seen in FIG. 3A, respectively;

FIGS. 4A and 4B are diagrams showing partial perspective and plan views, respectively, of a top surface of a plug insulator;

FIG. 5 is a perspective view of a ground contact of the plug shown in FIG. 2;

FIGS. 6A and 6B are diagrams showing an ordinary cable and a cable according to the embodiment of the present invention, respectively;

FIGS. 7A, 7B and 7C are diagrams showing partial perspective, partial front cross-sectional and partial side cross-sectional views of a top cover and signal connector pressure-connection portion; and

FIG. 8 is a perspective view of the signal contacts and ground contacts of the jack according to the embodiment of the present invention.

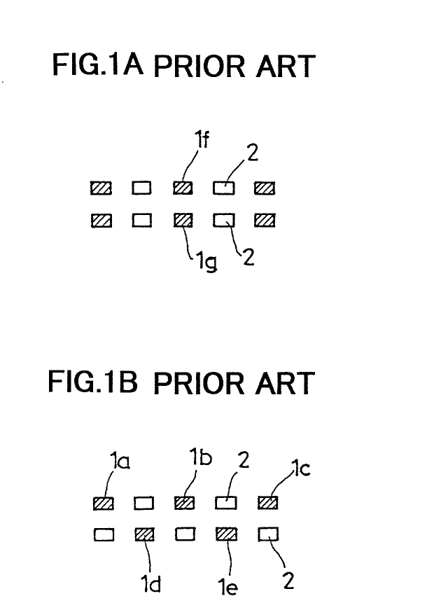

### DESCRIPTION OF THE PREFERRED EMBODIMENTS

A description will now be given of an embodiment of the present invention, with reference to the accompanying drawings.

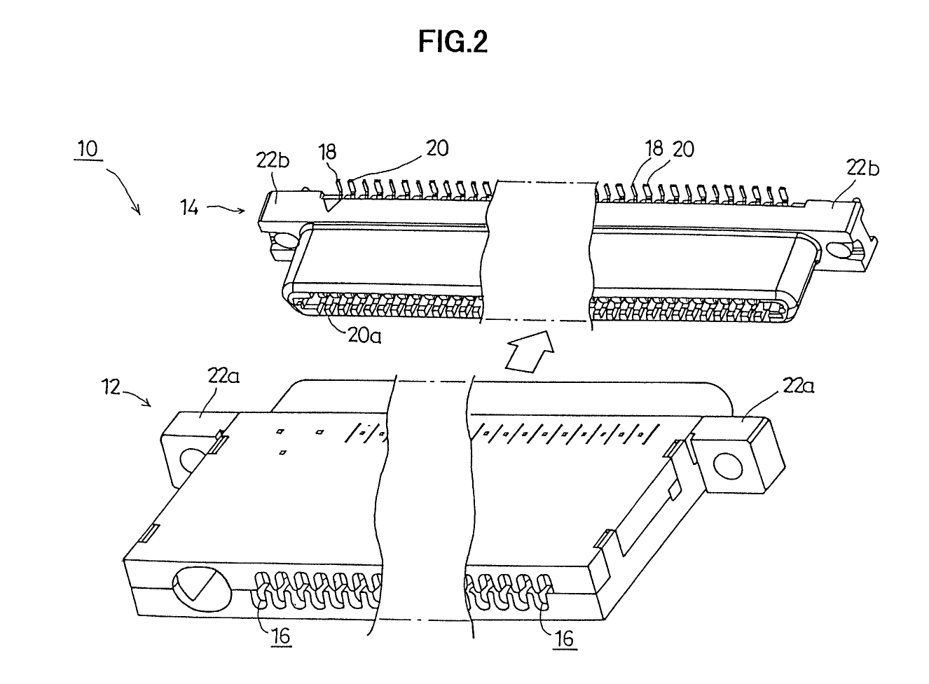

FIG. 2 is a perspective view of a connector according to an embodiment of the present invention, in which a plug 12 and a jack 14 form the connector. A plurality of holes 16 are formed on a near edge of the plug 12. A cable, not shown in the drawing, is attached to the holes 16. A plurality of signal contacts 18 and ground contacts 20 are provided on a far side of the jack 14. Signal contact tips 18 and ground contact tips 20 are soldered to printed circuits on a printed circuit board not shown in the drawing.

The plug 12 and the jack 14 engage between the terminals, in the direction of the arrow shown in FIG. 2. Engaging portions 22a, 22b on both sides of the plug and the jack, respectively, are fixedly mounted in place by an engaging member not shown in the drawing, completing connection.

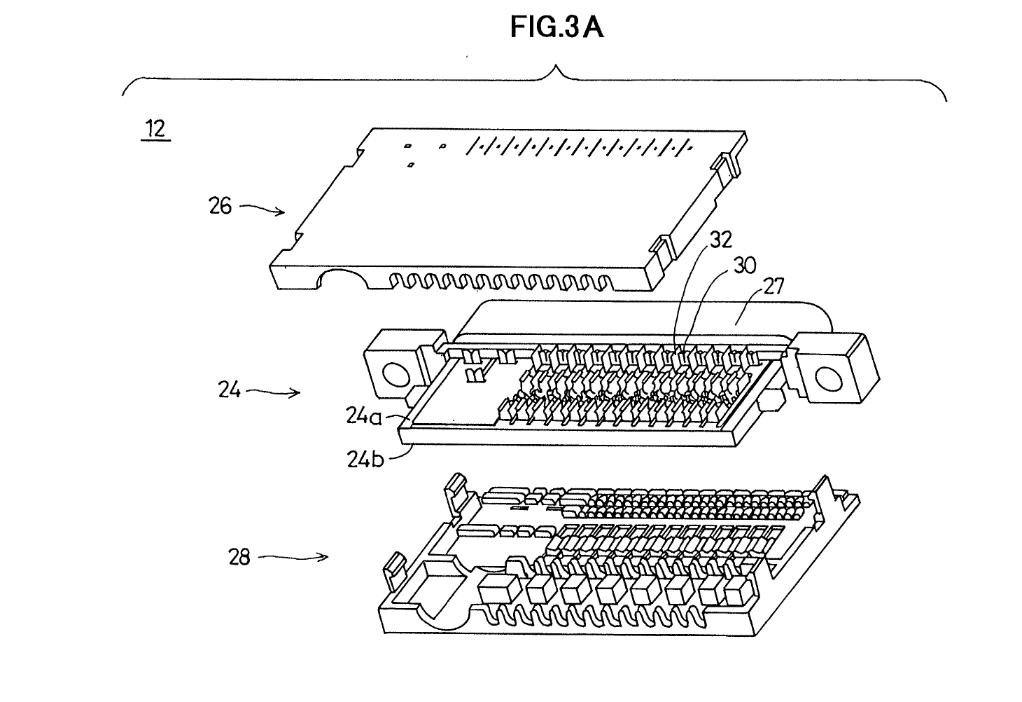

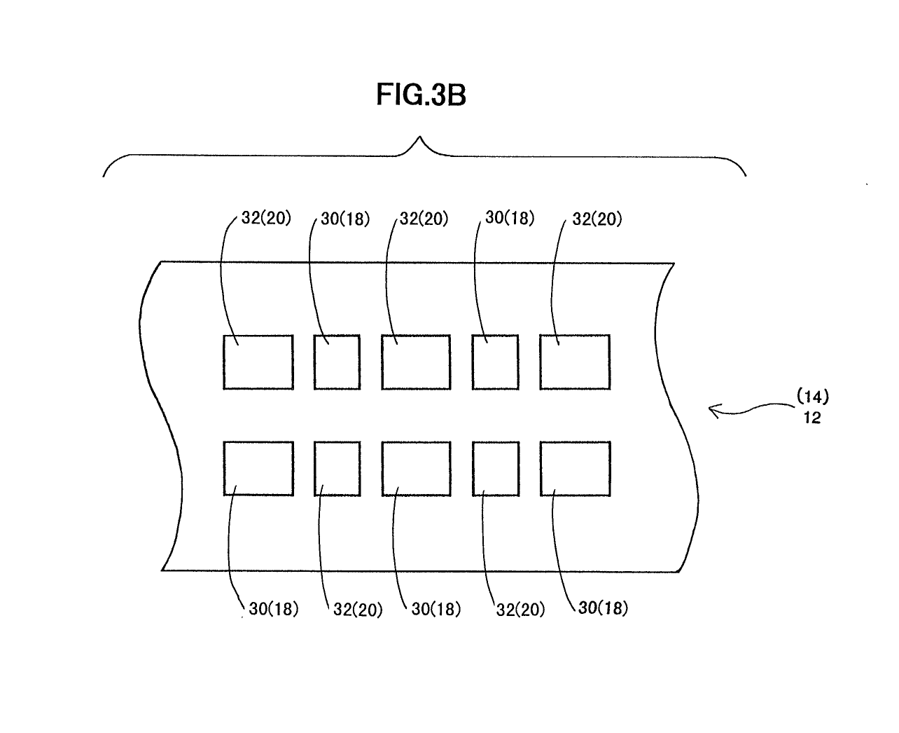

FIG. 3A is an expanded perspective view of the plug 12 shown in FIG. 2. The plug 12 comprises a plug insulator 24, a plug case 27, an upper cover 26 and a lower cover 28. Signal contacts 30 of the plug 12 and ground contacts 32 of the plug 12 are arranged in alternating sequence on both an upper surface 24a and a lower surface 24b of the plug insulator 24. It should be noted that the lower surface 24b of the plug insulator 24 is not shown in the diagram but nevertheless has the same structure as the upper surface 24a, the two surfaces 24a and 24b thus having identical structures formed symmetrically with respect to the plug insulator 24 central plastic layer portion. The signal contacts 30 of the plug 12 as well as ground contacts 32 of the plug 12 are arranged in alternating sequence in two parallel rows, the two rows having opposed sequences such that a signal contact in one row is opposed by a ground contact in the other row and vice versa, on the upper and lower surfaces 24a and 24b.

It should be noted that, like the plug 12, the jack 14 also has signal contacts 18 and ground contacts 20 arranged in alternating sequence in two parallel rows, the two rows having opposed sequences such that a signal contact in one row is opposed by a ground contact in the other row and vice versa.

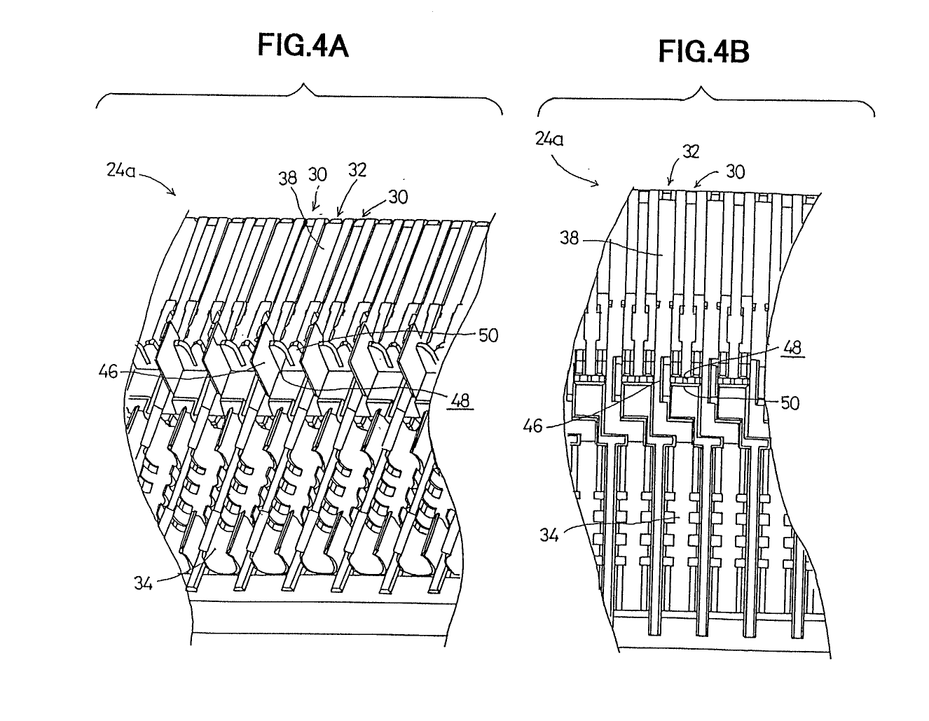

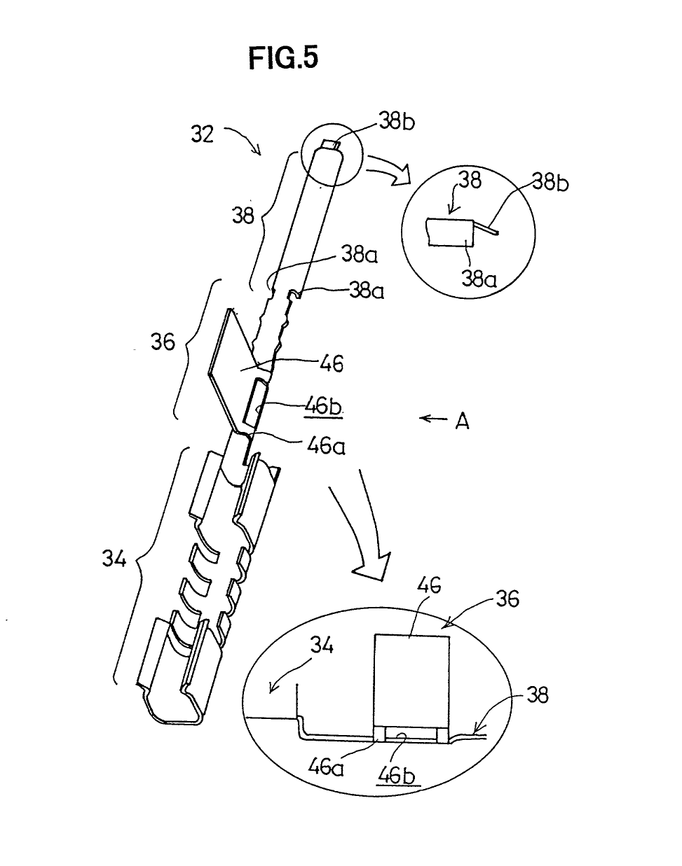

FIG. 4A shows a partial expanded perspective view of the upper surface 24a of the plug insulator 24 shown in FIG. 3A and FIG. 4B shows a partial expanded plan view of the upper surface 24a of the plug insulator 24. Additionally, FIG. 5 shows a perspective view of the ground contact 32 of the plug 12.

The ground contact 32 is formed using electrically conductive metallic material, and comprises a cable engaging portion 34, a conjoining portion 36 disposed adjacent to a signal contact pressure-contacting portion 50 to be described later, and a jack engaging portion 38. The cable engaging portion 34 is formed so that both sides arc upward to form an elongated section substantially U-shaped in cross-section. A plurality of notches are cut into the cable engaging portion 34, essentially forming the cable engaging portion 34 into a plurality of symmetrical prongs. Either a protective rubber sheath portion 42 or a metallic mesh shield portion 44 of a cable 40 is inserted into this elongated U-shaped cable engaging portion 34 and the prongs are then closed around that portion of the cable 40 so inserted.

A substantially rectangular ground shield 46 is formed on the conjoining portion 36 disposed adjacent to the pressure-contacting portion 50 of the signal contact, the ground shield 46 being of a fixed uniform width along the longitudinal dimension of the ground contact 32 and bent upward in a semicircular arc section 46c from the conjoining portion so as to be disposed at essentially a right angle to the longitudinal axis of the ground contact 32. This semicircular arc section 46a is further provided with a longitudinal slit 46b. The entire conjoining portion 36 is lowered slightly below the longitudinal axis of the ground contact 32, as indicated in FIG. 5.

Sides 38a of the jack engaging portion 38 of the ground contact 32 are bent downward in an arc to form substantially an inverted U shape in cross-section, with the tip 38b of the jack engaging portion 38 bent downward as indicated in FIG. 5.

The shape of the ground contact 32 as described above is such that, as shown in FIG. 5A, the signal contact pressure-contacting portion 50 of the signal contact 30, having a substantially V-shaped aperture 48 formed thereon, can be positioned adjacent to the vicinity of the ground shield 46 of the ground contact 32, and, accordingly, the distance between the signal contact 30 and the ground contact 32, that is, the pitch between terminals, can be decreased. The core 41 of the cable 40 engages the aperture 48 of the signal contact pressure-contacting portion 50 with the cable 40 and core 41 in essentially a straight, unbent condition.

Additionally, crosstalk is reduced because the ground shield 46 of the ground contact 32 is disposed so as to shield that portion of the upper surface 24a of the plug insulator 24 opposite an area between adjacent signal contacts 30, 30.

Additionally, because the sides 38a of the jack engaging portion 38 of the ground contact 32 are bent downward in an arc to form substantially an inverted U shape in cross-section as described above, when the plug 12 engages the jack 14 the forward tip 20a of the ground contact 20 of the jack 14 can be inserted smoothly into the ground contact 32 of the plug 12, thus preventing, for example, detachment of any plating formed on the surface of the ground contact 32.

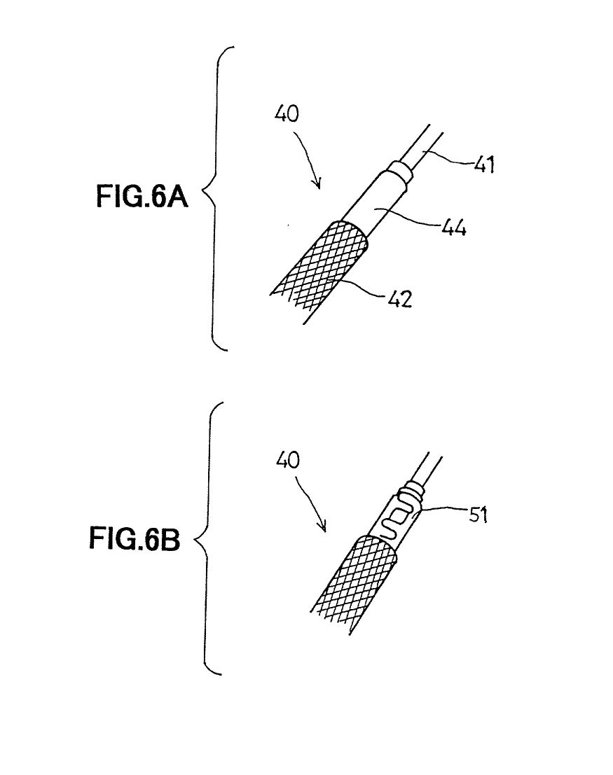

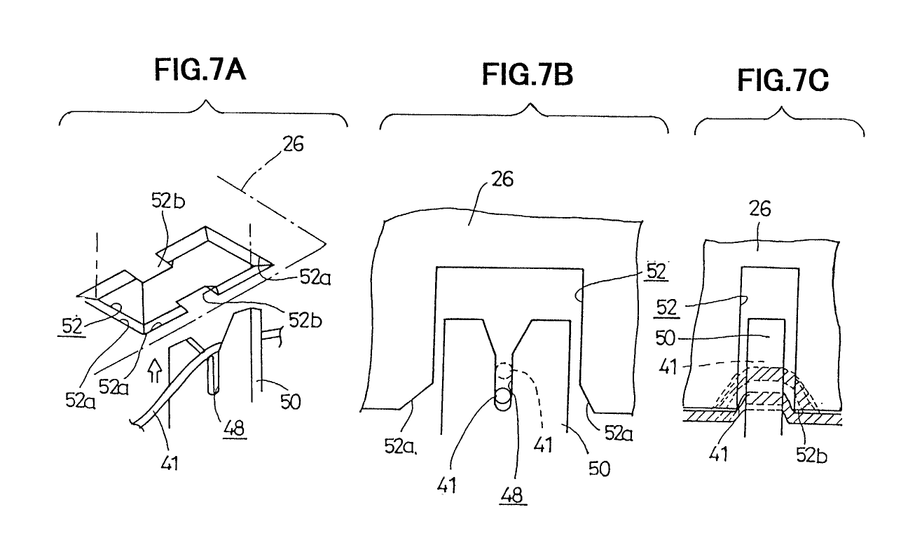

It should be noted that an aperture 52 is formed in the upper cover 26 shown in FIG. 6 for the purpose of inserting the signal contact pressure-contacting section 50. However, instead of the conventional aperture in which the entire periphery of the opening is tapered toward the interior of the aperture 52 to form a tapered portion 52a, an opening may be used in which no tapered portion 52a is formed on a side wall portion 52b of the opening perpendicular to the core 41 of the cable 40 as shown in FIG. 7A.

According to the configuration described above, the core 41 of the cable 40 is engaged by the aperture 48 of the signal contact pressure-contacting section 50 so that, when the signal contact pressure-contacting section 50 is inserted into the aperture 52, the core 41 of the cable 40 is not inserted so deeply into the aperture 52 by the tapered portion 52a so as to bend like the core 41 of the conventional cable 40 indicated by the dotted lines in FIG. 7B and FIG. 7C. Instead, the cable 40 and core 41 engaged near the bottom of the aperture 48 of the signal contact pressure-contacting portion 50 in essentially a straight, unbent condition. As a result, the walls of the aperture 48 of the signal contact pressure-contacting section 50 are able to remove the cover insulation from the core 41, which has been engaged with the cover insulation still intact, thus providing an improved electrical connection between the signal contact 30 and the core 41.

It should be noted that the lower cover 28 can be made to have the same structure as the upper cover 26 described above.

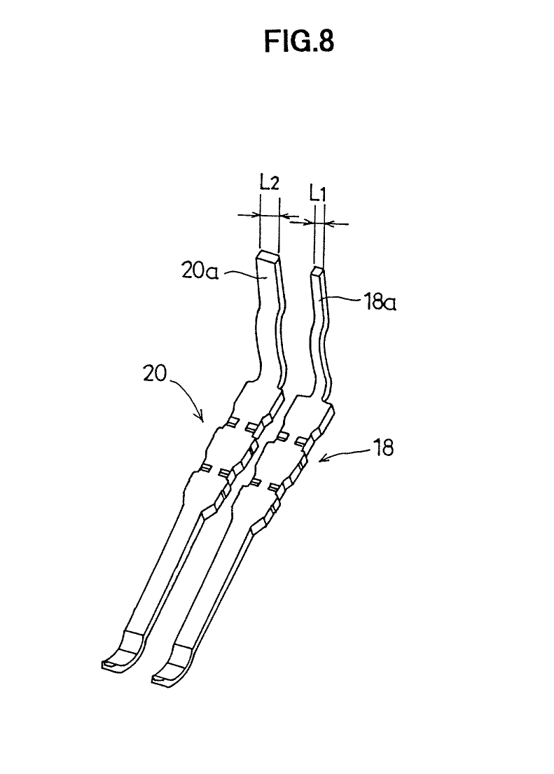

Next, FIG. 8 is a diagram showing a perspective schematic view of the signal contacts 18 and ground contacts 20 of the jack 14 shown in FIG. 2 according to an embodiment of the present invention. As can be appreciated from the drawing, the width L2 of a tip 20a of a ground contact 20 bent upward is greater than a width L1 of a tip 18a of a signal contact 18 bent upward. As a result of this enlargement of the width L2 of the tip 20a of the ground contact 20, crosstalk can be reduced to a greater extent than would be possible with ground contacts having a narrower width, for example, a width identical to the width L1 of tip 18a of the signal contact 18.

The above description is provided in order to enable any person skilled in the art to make and use the invention and sets forth the best mode contemplated by the inventors of carrying out the invention.

The present invention is not limited to the specifically disclosed embodiment, and variations and modifications may be made without departing from the scope of the present invention.

The present application is based on Japanese Priority Application No. 11-048509, filed on Feb. 25, 1999, the entire contents of which are hereby incorporated by reference.

What is claimed is:

1. A plug having a plurality of signal contacts and a plurality of ground contacts arranged in alternating sequence in two parallel rows, the two rows having opposed sequences such that a signal contact in one row is opposed by a ground contact in the other row and vice versa, a shield portion being provided on each ground contact.

2. A plug having a plurality of signal contacts ad a plurality of ground contacts arranged in alternating sequence in two parallel rows, the two rows having opposed sequences such that a signal contact in one row is opposed by a ground contact in the other row and vice versa, each ground contact having a jack engaging portion, the jack engaging portion having a size which shields a region opposite signal contacts between which one of the ground contacts is disposed.

3. A plug having a plurality of signal contacts and a plurality of ground contacts arranged in alternating sequence in two parallel rows, the two rows having opposed sequences such that a signal contact in one row is opposed by a ground contact in the other row and vice versa, a ground shield being extended from a conjoining portion of one of the ground contacts adjacent to a pressure-contacting portion of a respective one of the signal contacts.

4. A jack having a plurality of signal contacts and a plurality of ground contacts arranged in alternating sequence in two parallel rows, the two rows having opposed sequences such that a signal contact in one row is opposed by a ground contact in the other row and vice versa, a shield portion being provided on each ground contact.

5. A jack having a plurality of signal contacts and a plurality of ground contacts arranged in alternating sequence in two parallel rows, the two rows having opposed sequences such that a signal contact in one row is opposed by a ground contact in the other row and vice versa, each ground contact having a plug engaging portion, the plug engaging portion having a size which shields a region opposite signal contacts between which one of the ground contacts is disposed.

6. A connector comprising:
a plug having a plurality of signal contacts and a plurality of ground contacts arranged in alternating sequence in two parallel rows, the two rows having opposed sequences such that a signal contact in one row is opposed by a ground contact in the other row and vice versa, each ground contact having a jack engaging portion, the jack engaging portion having a size which shields a region opposite signal contacts between which one of the ground contacts is disposed; and
a jack engageable with said plug.

7. A connector comprising:
a jack having a plurality of signal contacts and a plurality of ground contacts arranged in alternating sequence in two parallel rows, the two rows having opposed sequences such that a signal contact in one row is opposed by a ground contact in the other row and vice versa, each ground contact having a plug engaging portion having a size which shields a region opposite signal contacts between which one of the ground contacts is disposed; and
a plug engageable with said jack.
